(19) United States
(12) Patent Application Publication
(10) Pub. No.: US 2017/0148292 A1
(43) Pub. Date: May 25, 2017

(54) AUTO HOLD OFF FOR RF DEVICE READERS OR DEACTIVATORS

(71) Applicant: CHECKPOINT SYSTEMS, INC., Thorofare, NJ (US)

(72) Inventor: Joseph R. Galanti, Blackwood, NJ (US)

(21) Appl. No.: 14/947,549

(22) Filed: Nov. 20, 2015

(51) Int. Cl. G08B 13/24

(52) U.S. Cl. CPC G08B 13/2417; G08B 13/242

(57) ABSTRACT

A method of performing dynamic hold-off period calculation for a tag monitoring device configured to monitor a security tag adapted to be disposed on a corresponding product in a monitoring environment may include receiving information indicative of transmission of a periodic signal pulse during a transmit cycle of a transmitter in the monitoring environment, setting an initial hold-off period defining a period during which the receiver is disabled after an end of the transmit cycle, enabling the receiver for a predetermined period of time after the initial hold-off period, and determining an adjustment to the hold-off period based on whether information indicative of the ring down waveform is detected during the predetermined period of time.

### TECHNICAL FIELD

Various example embodiments relate generally to retail theft deterrent and merchandise protection devices, and more particularly relate to methods and devices for improving the functioning of security tags employed for such purposes.

### BACKGROUND

Security devices have continued to evolve over time to improve the functional capabilities and reduce the cost of such devices. Some security devices are currently provided to be attached to individual products or objects in order to deter or prevent theft of such products or objects. In some cases, the security devices include tags or other such components that can be detected by gate devices at the exit of a retail establishment and/or tracked while being moved in the retail establishment. These tags may sometimes also be read for inventory management purposes, and may include or otherwise be associated with specific information about the type of product to which they are attached.

In order to improve the ability of retailers to deter theft and/or manage inventory, the security devices and systems in which they operate are continuously being improved. For example, various improvements may be introduced to attempt to improve the ability of gates placed at the exits of retail establishments to detect the tags. In this regard, the gates may occasionally produce false alarms or fail to detect tags passing through the gates. When such situations are noted, field servicing and the corresponding costs associated therewith may be incurred to try to optimize system performance. Additionally, the initial setup of the system may be an onerous task aimed at trying to optimize system performance.

Accordingly, the ability to provide good accuracy of detecting the tags with relatively little setup and maintenance may be considered to be an important aspect when determining the appropriate balance of characteristics for a given system.

### BRIEF SUMMARY OF SOME EXAMPLES

Some example embodiments may provide tag detection that is accurate, but also is not difficult to initialize and maintain. In this regard, some example embodiments may enable an automatic hold-off to be calculated for devices that read tags. The automatic hold-off may be employed to improve system performance without creating side effects that might impact the performance of other system components.

In one example embodiment, a tag monitoring device configured to interface with a security tag adapted to be disposed on a corresponding product in a monitoring environment is provided. The tag monitoring device may include a transmitter configured to transmit a periodic signal pulse during a transmit cycle, a receiver configured to monitor for a response from the security tag after the transmit cycle, and processing circuitry configured to control the receiver with respect to enabling the receiver to detect the response based on a hold-off period. The hold-off period defines a period during which the receiver is disabled after an end of the transmit cycle. The hold-off period is dynamically adjustable via the processing circuitry causing execution of a hold-off period tuning cycle.

According to another example embodiment, a security system is provided. The security system may include at least one security tag disposed on a product in a monitoring environment, and a tag monitoring device configured to interface with the at least one security tag. The tag monitoring device includes a transmitter configured to transmit a periodic signal pulse during a transmit cycle, a receiver configured to monitor for a response from the security tag after the transmit cycle, and processing circuitry configured to control the receiver with respect to enabling the receiver to attempt to detect the response based on a hold-off period. The hold-off period defines a period during which the receiver is disabled after an end of the transmit cycle. The hold-off period is dynamically adjustable via the processing circuitry causing execution of a hold-off period tuning cycle.

In another example embodiment, a method of performing dynamic hold-off period calculation for a tag monitoring device configured to monitor a security tag adapted to be disposed on a corresponding product in a monitoring environment is provided. The method may include receiving information indicative of transmission of a periodic signal pulse during a transmit cycle of a transmitter in the monitoring environment, setting an initial hold-off period defining a period during which the receiver is disabled after an end of the transmit cycle, enabling the receiver for a predetermined period of time after the initial hold-off period, and determining an adjustment to the hold-off period based on whether information indicative of the ring down waveform is detected during the predetermined period of time.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a conceptual diagram of a monitoring environment within a retail store according to an example embodiment;

FIG. 2 illustrates a block diagram of tag monitoring equipment (or a tag monitoring device) that may be employed to monitor tags that may be placed on objects in the monitoring environment in accordance with an example embodiment;

FIG. 3 illustrates a signal diagram demonstrating how tag ring down time and the hold-off period may be related in accordance with an example embodiment;

FIG. 4 illustrates a block diagram of a hold-off tuning cycle in accordance with an example embodiment; and

FIG. 5 illustrates a block diagram showing a method of performing dynamic hold-off period calculation for a tag monitoring device configured to monitor a security tag adapted to be disposed on a corresponding product in a monitoring environment in accordance with an example embodiment.

### DETAILED DESCRIPTION

Some example embodiments now will be described more fully hereinafter with reference to the accompanying drawings, in which some, but not all embodiments are shown. Indeed, the examples described and pictured herein should not be construed as being limiting as to the scope, applicability or configuration of the present disclosure. Like reference numerals refer to like elements throughout. Furthermore, as used herein, the term “or” is to be interpreted as a logical operator that results in true whenever one or more of its operands are true. As used herein, “operable coupling” should be understood to relate to direct or indirect connection that, in either case, enables at least a functional interconnection of components that are operably coupled to each other.

As used in herein, the terms “component,” “module,” and the like are intended to include a computer-related entity, such as but not limited to hardware, firmware, or a combination of hardware and software. For example, a component or module may be, but is not limited to being, a process running on a processor, a processor, an object, an executable, a thread of execution, and/or a computer. By way of example, both an application running on a computing device and/or the computing device can be a component or module. One or more components or modules can reside within a process and/or thread of execution and a component/module may be localized on one computer and/or distributed between two or more computers. In addition, these components can execute from various computer readable media having various data structures stored thereon. The components may communicate by way of local and/or remote processes such as in accordance with a signal having one or more data packets, such as data from one component/module interacting with another component/module in a local system, distributed system, and/or across a network such as the Internet with other systems by way of the signal. Each respective component/module may perform one or more functions that will be described in greater detail herein. However, it should be appreciated that although this example is described in terms of separate modules corresponding to various functions performed, some examples may not necessarily utilize modular architectures for employment of the respective different functions. Thus, for example, code may be shared between different modules, or the processing circuitry itself may be configured to perform all of the functions described as being associated with the components/modules described herein. Furthermore, in the context of this disclosure, the term “module” should not be understood as a nonce word to identify any generic means for performing functionalities of the respective modules. Instead, the term “module” should be understood to be a modular component that is specifically configured in, or can be operably coupled to, the processing circuitry to modify the behavior and/or capability of the processing circuitry based on the hardware and/or software that is added to or otherwise operably coupled to the processing circuitry to configure the processing circuitry accordingly.

Some example embodiments may relate to improvement of a system and devices capable of detecting security devices (e.g., tags) that are attached to objects such as retail products. Detection of the tags may sometimes occur within the context of electronic article surveillance (EAS). EAS gates may be provided at a location, such as the exit of a store, to detect tags that have not been removed or deactivated from products by a store clerk when properly purchased at a point of sale. The EAS gates at store exits are familiar sights, in the form of detection pedestals. The EAS gates may use magnetic, acousto-magnetic, radio frequency (RF), microwave, combinations of the above, or other detection methods for detecting tags. Of note, an example embodiment will be described in the context of a high frequency pulse (e.g., 3 MHz to 30 MHz). However, other periodic signals or waveforms (e.g., sinusoids, square waves, etc), having corresponding other frequencies that are generated for a finite period of time followed by a generally longer off period may also be employed.

When RF tags are employed, the tags are often designed as essentially an LC tank circuit with a resonance peak in a desired frequency band. The EAS gates can sweep around the resonant frequency to detect the presence of an RF tag. The RF tags can be removed at the point of sale, or can be deactivated using a deactivator that is configured to submit the RF tag that is to be deactivated to a strong electromagnetic field that can break down, for example, a capacitor of the LC tank circuit. The deactivator may, in some cases, be a deactivation pad over which the RF tags are passed for deactivation.

In some cases, EAS devices that employ RF sensing have a pulsed high frequency (HF) amplifier to provide current to drive either deactivation pads or detection pedestals. The pulsating high current condition does not immediately dissipate after a pulse is generated. Instead, due to the various interactions created by the circuitry that is operably coupled to these components, there may be some ringing and settling that occurs after the pulse is generated. Accordingly, after RF is disabled between different interfacing antennas and pedestals, corresponding different ringing and settling times may be experienced. If the electronics (i.e., the circuitry) of such components are not allowed to settle properly before enabling receivers of such devices to attempt subsequent detections, the receivers may essentially hear themselves and cause a false alarm. In other words, if the receiver is enabled while ringing is occurring before the circuitry has settled, the receiver may detect the ringing and trigger a false alarm.

This dissipation of ringing during the settling process may be referred to as tag ring down. To avoid false alarms, sampling by the receiver may be inhibited for a sufficient time to avoid detection of the ringing after an HF pulse or another periodic signal. This time period during which the receiver is inhibited may be referred to as a hold-off period. However, detection capability is also inhibited during this time (i.e., during the hold-off period). Thus, some detection opportunities could be missed if the hold-off period is too long, and false alarms could occur if the hold-off period is too short. One way to deal with this issue may be to conduct testing and set a fixed value based on the test results. However, because the wiring and other circuitry involved in each and every installation of a system could be slightly different, and because different antenna interfaces may be employed while using the same general HF electronics, the tag ring down could be different in respective different systems. As such, there is no one size fits all answer to this problem.

One way to address the problem may be to send technicians to manually adjust away from a fixed sample delay as the hold-off period to try to manually optimize the hold-off period for each installed system using a tuning board or other service tool. However, this method would be labor intensive and costly. To address this issue, some example embodiments may provide for an auto hold-off feature that may automatically determine an optimal hold-off period for a system. Systems can therefore be tuned more easily and be much more “plug & play” oriented. Customers or technicians can therefore complete tuning after install, startup, or the provision of additional components into a system (e.g., deactivators), without the use of complicated service tools regardless of antenna configuration.

An example embodiment will be described herein as it relates to receiver equipment that is configured to interact with an RF security device (e.g., an RF tag) that can be attached to an object (e.g., a retail product). The receiver equipment may be equipment that is provided in a deactivator and/or a detection pedestal, among other devices for detecting the RF tag within a monitoring environment.

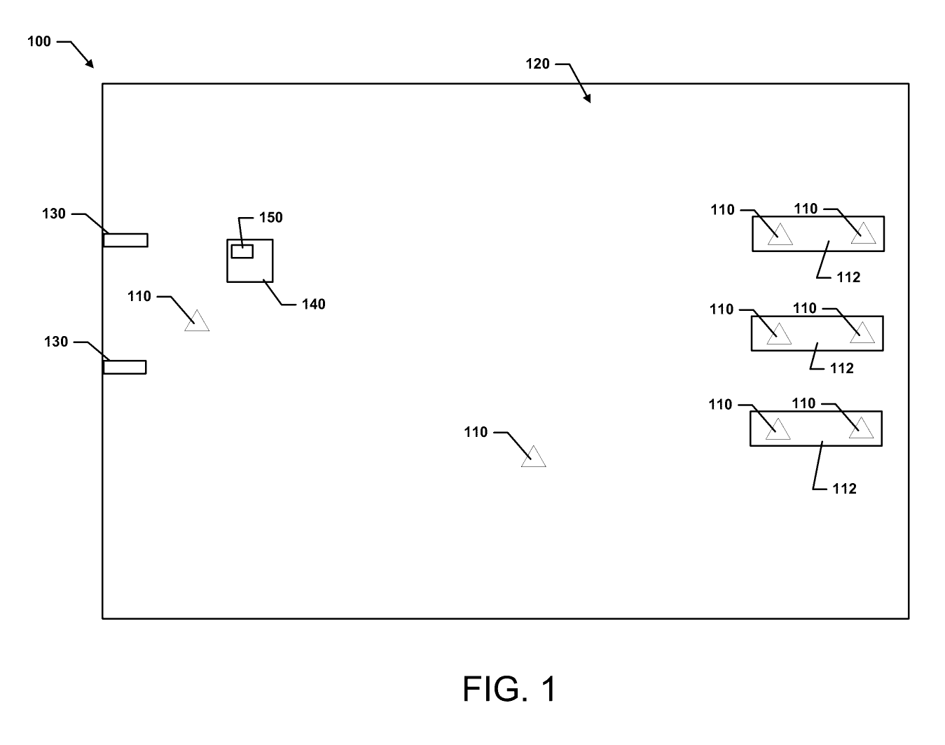

FIG. 1 illustrates a conceptual diagram of a monitoring environment 100 within a retail store. As shown in FIG. 1, the monitoring environment 100 may include a monitoring zone 120, which may represent a relatively large area of the store (e.g., the sales floor). Tags 110 may generally be monitored while they are in the monitoring zone 120, and a detection pedestal 130 may be provided at an exit from the monitoring zone 120 to detect passage of the tags 110 through the EAS gates provided by the detection pedestal 130. As shown in FIG. 1, the tags 110 may be disposed on products that may be provided on various product displays or racks 112, which may be at various locations throughout the monitoring zone 120.

The monitoring environment 100 may also include a point of sale 140 at which retail items may be purchased. At the point of sale 140, the store clerk may take payment for the products to which the tags 110 are attached. The store clerk may also employ a deactivator 150 at the point of sale 140 in order to deactivate the tags 110 after the purchasing transaction is completed for a tagged product.

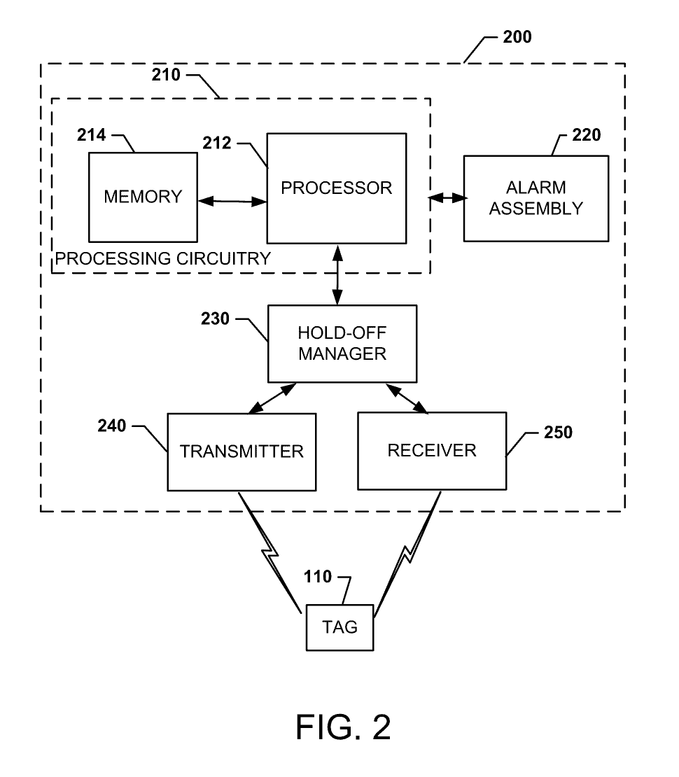

Based on the description above, it can be appreciated that both the deactivator 150 and the detection pedestal 130 may interact with the tags 110 at various times. The deactivator 150 and the detection pedestal 130 may therefore be considered to be examples of or otherwise devices that employ tag monitoring equipment 200. FIG. 2 illustrates a block diagram of tag monitoring equipment 200 (or a tag monitoring device) that may be employed to monitor tags 110 that may be placed on objects (products) in the monitoring environment 100 in accordance with an example embodiment.

As mentioned above, the interaction between tag monitoring equipment 200 and the tags 110 can be impacted by tag ring down. Thus, it may be desirable to control the hold-off period for any receiver that is listening for a response from the tags 110 after a pulse is generated by a transmitter of the tag monitoring equipment 200. As shown in FIG. 2, the tag monitoring equipment 200 may include processing circuitry 210 configured in accordance with an example embodiment as described herein. In this regard, for example, the tag monitoring equipment 200 may utilize the processing circuitry 210 to provide electronic control inputs to one or more functional units (which may be implemented by or with the assistance of the of the processing circuitry 210) of the tag monitoring equipment 200 to receive, transmit and/or process data associated with the one or more functional units and perform communications necessary to enable detection of tags, issuing of alarms and/or alerts, deactivation of tags and/or the like as described herein.

In some embodiments, the processing circuitry 210 may be embodied as a chip or chip set. In other words, the processing circuitry 210 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry 210 may therefore, in some cases, be configured to implement an embodiment on a single chip or as a single “system on a chip.” As such, in some cases, a chip or chipset may constitute means for performing one or more operations for providing the functionalities described herein.

In an example embodiment, the processing circuitry 210 may include one or more instances of a processor 212 and memory 214. As such, the processing circuitry 210 may be embodied as a circuit chip (e.g., an integrated circuit chip) configured (e.g., with hardware, software or a combination of hardware and software) to perform operations described herein. The processing circuitry 210 may interface with and/or control the operation of various other components of the tag monitoring equipment 200 including, for example, an alarm assembly 220, a hold-off manager 230, a transmitter 240 and a receiver 250.

The alarm assembly 220 (if included) may include an audio device (e.g., a piezoelectric, mechanical, or electromechanical beeper, buzzer, or other audio signaling device such as an audible alarm). The alarm assembly 220 may include a speaker or other sound generating device. In some example embodiments, the alarm assembly 220 may also or alternatively include visible indicia (e.g., lights of one or more colors such as a bi-color (e.g., red/green) LED). The visible indicia of the alarm assembly 220 and/or the audio device thereof may be used in various ways to facilitate notification of the detection of one of the tags 110 by the tag monitoring equipment 200.

The transmitter 240 may include components and circuitry for transmission of an HF pulse that may be provided at a particular frequency (e.g., the resonant frequency of the tags 110) or may be swept over a range of frequencies around the resonant frequency of the tags 110. The transmitter 240 may also include a transmission antenna (or array of antennas), a signal generator, amplification circuitry, cabling and/or the like. The transmitter 240 may generate the HF pulse under the control of the processing circuitry 210 for timing control purposes.

After the HF pulse is transmitted, the receiver 250 may be enabled to listen for return signals generated responsive to receipt of the HF pulse by one of the tags 110. The receiver 250 may therefore include a receive antenna (or array of antennas), filters, signal processing circuitry, amplifiers, cabling and/or the like. In some cases, some of the components of the receiver 250 and the transmitter 240 may be shared between them. However, in other cases, the transmitter 240 and receiver 250 may each include distinct components.

The receiver 250 and/or the transmitter 240 may be enabled for operation on a selective basis. In other words, the receiver and/or the transmitter 240 may not continuously operate, but may instead have their on and off periods controlled by the processing circuitry 210. More specifically, the hold-off manager 230 may be a module configured for the control of the receiver 250 and/or the transmitter 240. In an example embodiment, the hold-off manager 230 may be any means such as a device or circuitry embodied in either hardware, or a combination of hardware and software that is configured to control timing of enabling or operating the receiver 250 and/or the transmitter 240. As such, the hold-off manager 230 may be configured to either enable or disable either or both of the receiver 250 and/or the transmitter 240 to control the timing of the operation of such devices either generally or in relation to each other.

In an example embodiment, the hold-off manager 230 may be configured to control at least the receiver 250 in order to modify the hold-off period from an initial setting or set point to achieve an adjusted setting or set point that may be determined to have a high likelihood of avoiding false alarms, but also reduce the likelihood of missing any valid detection of the tag 110. In this regard, the hold-off manager 230 may be configured to dynamically adjust the hold-off period (from the initial setting) to optimize tag detection via a hold-off tuning cycle. After the hold-off tuning cycle is completed by the hold-off manager 230, the hold-off period defined by the hold-off tuning cycle may be employed until a trigger condition occurs to initiate another hold-off tuning cycle.

In an example embodiment, the trigger condition may be any of a number of different events. In some cases, the trigger condition could be a manually inserted command by a technician or store employee, which could be initiated after installation of a system employing the tag monitoring equipment 200. The manually inserted command may alternatively be inserted as part of or after the completion of maintenance or repair. However, in other situations, the trigger condition could be powering up of the system or of the tag monitoring equipment 200. In an example embodiment, the trigger condition could be defined by recognition of any of a plurality of different events. Thus, the trigger condition could be automatically inserted in response to various events such as, for example, satisfaction of a temporal condition (e.g., a time period since the last hold-off tuning cycle), a performance related condition (e.g., occurrence of a predetermined number or rate of false alarms), and/or the like.

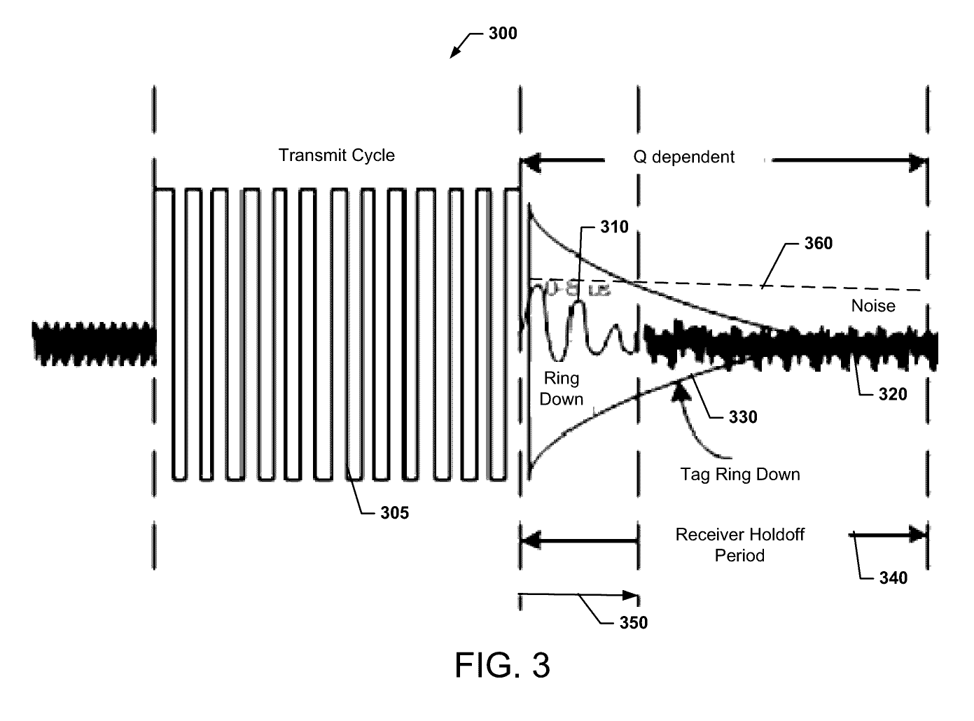

FIG. 3 illustrates a signal diagram demonstrating how tag ring down time and the hold-off period may be related in accordance with an example embodiment. As shown in FIG. 3, the transmitter 240 may generate a transmit cycle 300 for a given period of time. After the periodic signal pulse 305 is disabled (e.g., by the processing circuitry 210 and/or the hold-off manager 230 after, for example, about 4 μs), the tuned resonances (e.g., capacitance and inductance) of the electronic components in the system take time to discharge or settle out. Thus, a ring down signal 310 is generated. The ring down signal 310 may eventually reach the ambient noise level 320, and become lost in the noise. In this example, the ring down time is about 8 μs. FIG. 3 also shows a tag ring down envelope 330 that would be generated if the tag 110 was present. As can be seen from FIG. 3, the tag ring down envelope may be slightly longer in duration than the ring down signal 310.

In some cases, an average or initial tag ring down time may be defined for a system or device, and the system may have an initial receiver hold-off period 340 that is defined to ensure that the average or initial tag ring down time is accounted for so that the receiver 250 stays off and does not listen for returns until the ring down signal 310 (if no tag is present) or the tag ring down envelope 330 (if a tag is present) has dissipated. Thus, for example, the hold-off manager 230 may define the initial receiver hold-off period 340 to keep the receiver 250 off at least long enough to cover the tag ring down envelope 330 in most cases.

As mentioned above, if the receiver 250 is listening during the time at which the ring down signal 310 or tag ring down envelope 330 is significant (i.e., before the tag ring down signal 310 or tag ring down envelope 330 dissipates to a predetermined level (e.g., to fade into the noise)), then the receiver 250 may detect the tag ring down signal 310 or tag ring down envelope 330 and generate a false alarm. Thus, by keeping the receiver 250 off for the initial receiver hold-off period 340, the tag ring down signal 310 will not be detected in this example. Moreover, since the initial receiver hold-off period 340 may be sufficient to ensure that the tag ring down envelope 330 is accounted for in most systems, most cases would not trigger a false alarm.

However, the duration of the tag ring down time is dependent upon the Q of the system, and the Q of the system may be different in corresponding different cases. Thus, example embodiments may employ the hold-off manager 230 to define the hold-off tuning cycle in order to support systems having different Qs by dynamically adjusting away from the initial receiver hold-off period 340 (in either direction) to provide an optimized hold-off period for the system.

In the example of FIG. 3, since the ring down time (associated with tag ring down signal 310 and tag ring down envelope 330 each appear to be significantly less than the initial receiver hold-off period 340, the hold-off tuning cycle may be employed to adjust the hold-off period 350 to a shorter duration. In this example, the hold-off tuning cycle is employed to shorten the hold-off period 350 to a time period that defines the amount of time it takes for the tag ring down signal 310 and tag ring down envelope 330 to dissipate to a predefined threshold 360.

In an example embodiment, the hold-off tuning cycle may be performed to determine where to set the hold-off period 350 by starting at an arbitrary value and then testing for fast returns until the system is tuned so that the first sample (i.e., of the receiver 250) occurs right after the natural ring down in order to obtain the maximum or optimal sensitivity. In some cases, the hold-off tuning cycle may begin by starting at a reasonably close sampling point (e.g., 1 μs). The receiver 250 may be enabled for 10 μs for each hold-off period measurement. This will ensure that only synchronized (resonance) noise and not random noise will be captured. At least 20 frames (e.g., 140 μs) may be measured to determine whether any information indicative of a ring down waveform (e.g., false alarms or tag interrupts) are detected. In some cases, raw tag interrupts may be measured before using any tag rate filtering. If information indicative of the ring down waveform is detected, the sampling point may be extended, and the 20 frame measurement period may be recommenced. This process may be repeated until no interrupts or other information indicative of the ring down wave form is experienced during the 20 frame measurement for a given hold-off period setting. In some cases, if no interrupts or other information indicative of the ring down wave form is experienced, the same hold-off period may be employed again to require two consecutive measurement cycles at the same hold-off period before the hold-off period 350 can be established.

Once the hold-off period 350 is established, the value can be stored in non-volatile memory and, if a service tool is connected, may also be displayed at the service tool. The service tool may further give the operator an option to override the automatically determined hold-off period 350. Thus, for example, the operator may extend or shorten the value of the automatically determined hold-off period 350. In some cases, the range of hold-off period values may end up in a range between 1 μs and 10 μs. This would give a worst case run time of about 2 seconds. However, other values are also possible, for other systems.

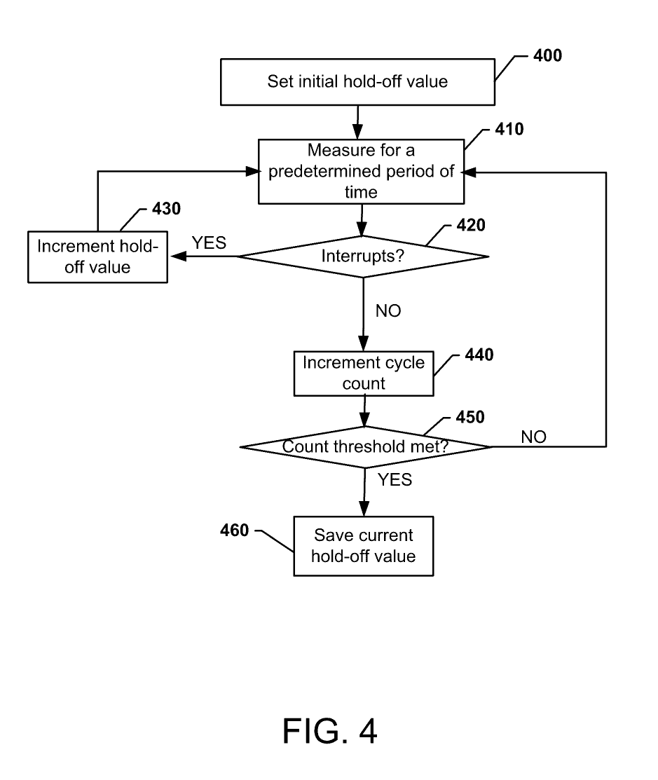

FIG. 4 illustrates a block diagram of the hold-off tuning cycle in accordance with an example embodiment. As shown in FIG. 4, an initial hold-off value may be defined at operation 400. As mentioned above, the initial hold-off value may be a reasonable value for the system, but one which defines a relatively short delay. At operation 410, the receiver 250 may be enabled and measurements may occur for a predetermined period of time (e.g., 20 frames). A determination may then be made at operation 420 as to whether any interrupts are detected at the receiver 250. If interrupts are detected, then the hold-off value may be incremented by a predetermined incremental value (e.g., 1.5 μs) at operation 430, and flow may return to operation 410. If no interrupts were detected at operation 420, then a cycle count value may be incremented at operation 440. A determination may then be made, at operation 450, as to whether a count threshold is met. If the count threshold is not met, flow may return to operation 410 so that the cycle can be repeated at the current hold-off value. This will allow at least a number of cycles equal to the count threshold (which may be any integer value) to be completed without interrupts before the hold-off period 350 can be set. Thus, if the count threshold is met at operation 450, then the current hold-off value (i.e., the initial hold-off value plus the count cycle number times the hold-off value incremental increase) may be saved (e.g., in memory 214) and employed after each transmit cycle 300.

In an example embodiment, a level detector may be provided in connection with measurement of the interrupts, so that the interrupts are measured when the level of response detected at the received 250 exceeds the predefined threshold 360. The level detector could be set at a level just above the level of the ambient noise 320, or at any other desirable level.

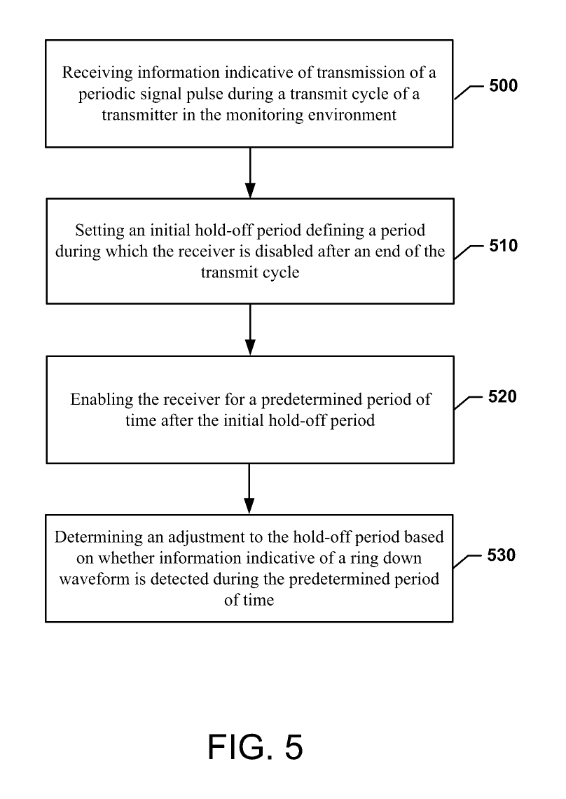

In an example embodiment, the processing circuitry 210 may therefore be configured to receive information indicative of a transmit cycle for tag monitoring equipment and maintain the receiver of the tag monitoring equipment disabled for at least a hold-off period, where the hold-off period is a period that is dynamically and automatically adjusted to achieve an optimized sampling initiation point to reduce false alarms and maintain optimal detection. The information indicative of the transmit cycle may include information indicative of termination of the transmit cycle or information indicative of a predetermined period after the initiation of the transmit cycle. Thus, from a technical perspective, the processing circuitry 210, as described above, may be used to support some or all of the operations described above. As such, the platform described in FIG. 2 may be used to facilitate the implementation of several computer program and/or network communication based interactions. As an example, FIG. 5 is a flowchart of an example method and program product according to an example embodiment. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a computing device and executed by a processor in the computing device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions. Such programming or instructions may, in some cases, transform the processing circuitry 210 into an automatic system tuning device that measures system response and adjusts system parameters automatically to control the timing operation of system devices.

In this regard, FIG. 5 illustrates a block diagram showing a method of performing dynamic hold-off period calculation for a tag monitoring device configured to monitor a security tag adapted to be disposed on a corresponding product in a monitoring environment. The method may include receiving information indicative of transmission of a periodic signal pulse during a transmit cycle of a transmitter in the monitoring environment at operation 500, setting an initial hold-off period defining a period during which the receiver is disabled after an end of the transmit cycle at operation 510, enabling the receiver for a predetermined period of time after the initial hold-off period at operation 520, and determining an adjustment to the hold-off period based on whether interrupts or other information indicative of the ring down waveform is detected during the predetermined period of time at operation 530.

In some embodiments, the features described above may be augmented or modified, or additional features may be added. These augmentations, modifications and additions may be optional and may be provided in any combination. Thus, although some example modifications, augmentations and additions are listed below, it should be appreciated that any of the modifications, augmentations and additions could be implemented individually or in combination with one or more, or even all of the other modifications, augmentations and additions that are listed. As such, for example, determining the adjustment to the hold-off period may include increasing time from the initial hold-off period to define an incremented hold-off value in response to information indicative of the ring down waveform being detected, measuring for additional information indicative of the ring down waveform during the predetermined period of time at the incremented hold-off value, and repeating the increasing time and measuring operations until no information indicative of the ring down waveform is detected. In an example embodiment, the hold-off period tuning cycle may be executed based on a temporal condition or based on a performance related condition. In some cases, the hold-off period tuning cycle is executed at power-up of the device. In some examples, the method may further include saving the determined adjustment to the hold-off period and applying the determined adjustment to the hold-off period after each subsequent transmit cycle.

Example embodiments may provide a security system that can effectively protect a product to which a security tag is attached from theft, by providing an automatically determinable hold-off period that minimizes false alarms and maximizes detection capabilities. By enabling the security device to be detected more effectively and with fewer false alarms, effectiveness may be increased while overall satisfaction of a retailer using instances of the security device to protect products may be improved.

Many modifications and other examples of the embodiments set forth herein will come to mind to one skilled in the art to which these embodiments pertain having the benefit of the teachings presented in the foregoing descriptions and the associated drawings. Therefore, it is to be understood that example embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A tag monitoring device configured to interface with a security tag adapted to be disposed on a corresponding product in a monitoring environment, the tag monitoring device comprising:
a transmitter configured to transmit a periodic signal pulse during a transmit cycle;
a receiver configured to monitor for a response from the security tag after the transmit cycle and responsive to the periodic signal pulse; and
processing circuitry configured to control the receiver to detect the response based on a hold-off period, the hold-off period defining a period during which the receiver is disabled after an end of the transmit cycle,
wherein the processing circuitry is further configured to execute a hold-off period tuning cycle, wherein the hold-off period tuning cycle includes the processing circuitry dynamically adjusting a duration of the hold-off period.

2. The device of claim 1, wherein the tag monitoring device comprises a tag detection pedestal or a deactivator.

3. The device of claim 1, wherein the hold-off period tuning cycle is executed based on a temporal condition.

4. The device of claim 1, wherein the hold-off period tuning cycle is executed based on a performance related condition.

5. The device of claim 1, wherein the hold-off period tuning cycle is executed at power-up of the device.

6. The device of claim 1, wherein the hold-off period tuning cycle comprises:
setting an initial hold-off period;
enabling the receiver for a predetermined period of time after the initial hold-off period; and
determining an adjustment to the hold-off period based on whether information indicative of a ring down waveform is detected during the predetermined period of time.

7. The device of claim 6, wherein determining the adjustment to the hold-off period comprises:
increasing time from the initial hold-off period to define an incremented hold-off value in response to the information indicative of the ring down waveform being detected,
measuring for additional information indicative of the ring down waveform during the predetermined period of time at the incremented hold-off value, and
repeating the increasing time and measuring operations until no information indicative of the ring down waveform is detected.

8. The device of claim 6, wherein determining the adjustment to the hold-off period comprises:
increasing time from the initial hold-off period to define an incremented hold-off value in response to the information indicative of the ring down waveform being detected,
measuring for additional information indicative of the ring down waveform during the predetermined period of time at the incremented hold-off value, and
repeating the increasing time and measuring operations until no information indicative of the ring down waveform is detected through at least two cycles of measurement of the predetermined period of time.

9. The device of claim 6, further comprising saving the determined adjustment to the hold-off period and applying the determined adjustment to the hold-off period after each subsequent transmit cycle.

10. A security system comprising:
at least one security tag disposed on a product in a monitoring environment; and
a tag monitoring device configured to interface with the at least one security tag, the tag monitoring device comprising:
a transmitter configured to transmit a periodic signal pulse during a transmit cycle;
a receiver configured to monitor for a response from the security tag after the transmit cycle and responsive to the periodic signal pulse; and
processing circuitry configured to control the receiver to detect the response based on a hold-off period, the hold-off period defining a period during which the receiver is disabled after an end of the transmit cycle,
wherein the hold-off period is dynamically adjustable via the processing circuitry causing execution of a hold-off period tuning cycle.

11. The security system of claim 10, wherein the tag monitoring device comprises a tag detection pedestal or a deactivator.

12. The security system of claim 10, wherein the hold-off period tuning cycle is executed based on a temporal condition.

13. The security system of claim 10, wherein the hold-off period tuning cycle is executed based on a performance related condition.

14. The security system of claim 10, wherein the hold-off period tuning cycle is executed at power-up of the device.

15. The security system of claim 10, wherein the hold-off period tuning cycle comprises:
setting an initial hold-off period;
enabling the receiver for a predetermined period of time after the initial hold-off period; and
determining an adjustment to the hold-off period based on whether information indicative of a ring down waveform is detected during the predetermined period of time.

16. The security system of claim 15, wherein determining the adjustment to the hold-off period comprises:
increasing time from the initial hold-off period to define an incremented hold-off value in response to the information indicative of the ring down waveform being detected,
measuring for additional information indicative of the ring down waveform during the predetermined period of time at the incremented hold-off value, and
repeating the increasing time and measuring operations until no information indicative of the ring down waveform is detected.

17. The security system of claim 15, wherein determining the adjustment to the hold-off period comprises:
increasing time from the initial hold-off period to define an incremented hold-off value in response to the information indicative of the ring down waveform being detected,
measuring for additional information indicative of the ring down waveform during the predetermined period of time at the incremented hold-off value, and
repeating the increasing time and measuring operations until no information indicative of the ring down waveform is detected through at least two cycles of measurement of the predetermined period of time.

18. The security system of claim 6, further comprising saving the determined adjustment to the hold-off period and applying the determined adjustment to the hold-off period after each subsequent transmit cycle.

19. A method of performing dynamic hold-off period calculation for a tag monitoring device configured to monitor a security tag adapted to be disposed on a corresponding product in a monitoring environment, the method comprising:
receiving information indicative of transmission of a periodic signal pulse during a transmit cycle of a transmitter in the monitoring environment;
setting an initial hold-off period defining a period during which the receiver is disabled after an end of the transmit cycle;
enabling the receiver for a predetermined period of time after the initial hold-off period; and
determining an adjustment to the hold-off period based on whether information indicative of a ring down waveform is detected during the predetermined period of time.

20. The method of claim 19, wherein determining the adjustment to the hold-off period comprises:
increasing time from the initial hold-off period to define an incremented hold-off value in response to the information indicative of the ring down waveform being detected,
measuring for additional information indicative of the ring down waveform during the predetermined period of time at the incremented hold-off value, and
repeating the increasing time and measuring operations until no information indicative of the ring down waveform is detected.
